(19) United States
(12) Patent Application Publication
(10) Pub. No.: US 2021/0333375 A1
(43) Pub. Date: Oct. 28, 2021

(54) TIME MEASUREMENT CORRECTION METHOD AND DEVICE

(71) Applicant: SZ DJI TECHNOLOGY CO., LTD., Shenzhen (CN)

(72) Inventors: Chuang WANG, Shenzhen (CN); Mingming GAO, Shenzhen (CN); Xiang LIU, Shenzhen (CN); Xiaoping HONG, Shenzhen (CN)

(21) Appl. No.: 17/371,938

(22) Filed: Jul. 9, 2021

Related U.S. Application Data
(63) Continuation of application No. PCT/CN2019/070959, filed on Jan. 9, 2019.

(51) Int. Cl. G01S 7/497; G04F 10/00; G01S 7/4865; G01S 17/14

(52) U.S. Cl. CPC G01S 7/497; G01S 17/14; G01S 7/4865; G04F 10/005

(57) ABSTRACT

A time measurement correction method includes a field programmable gate array (FPGA) determining to enter a self-correction mode of time measurement, and in the self-correction mode, the FPGA controlling to generate a standard signal and the FPGA controlling to obtain the standard signal and collecting measurement data of at least one TDC channel included in the FPGA based on the standard signal. The standard signal is used to correct the at least one TDC channel of the FPGA.

### CROSS-REFERENCE TO RELATED APPLICATION

This application is a continuation of International Application No. PCT/CN2019/070959, filed Jan. 9, 2019, the entire content of which is incorporated herein by reference.

### TECHNICAL FIELD

The present disclosure relates to the field of time measurement and, in particular, to method and device for time measurement correction.

### BACKGROUND

Time to digital converters (TDC) based on field programmable gate array (FPGA) are used to measure arrival time of signals and are therefore widely used in variety of distance measurement devices.

Time measurement accuracy of FPGA-based TDC is influenced by the physical device itself or environmental factors. Thus, how to correct the FPGA-based TDC has become a focus of attention.

### SUMMARY

In accordance with the disclosure, there is provided a time measurement correction method including a field programmable gate array (FPGA) provided with at least one time-to-digital conversion (TDC) channel determining to enter a self-correction mode of time measurement, and in the self-correction mode, the FPGA controlling to generate a standard signal and the FPGA controlling to obtain the standard signal and collecting measurement data of the at least one TDC channel based on the standard signal. The standard signal is used to correct the at least one TDC channel of the FPGA.

Also in accordance with the disclosure, there is provided a field programmable gate array (FPGA) including at least one time-to-digital conversion (TDC) channel and a control device. The control device is used to determine that the FPGA enters a self-correction mode of time measurement, and in the self-correction mode, control to generate a standard signal and control the FPGA to obtain the standard signal and collect measurement data of the at least one TDC channel based on the standard signal. The standard signal is used to correct the at least one TDC channel of the FPGA.

Also in accordance with the disclosure, there is provided a distance measurement device including a transmitter used to emit a laser pulse sequence and a field programmable gate array (FPGA). The FPGA includes at least one time-to-digital conversion (TDC) channel and a control device. The control device is used to determine that the FPGA enters a self-correction mode of time measurement, and in the self-correction mode, control to generate a standard signal and control the FPGA to obtain the standard signal and collect measurement data of the at least one TDC channel based on the standard signal. The standard signal is used to correct the at least one TDC channel of the FPGA. The FPGA is used to control the transmitter to emit the laser pulse sequence, receive an electrical pulse signal, and perform time measurement on the electrical pulse signal through the at least one TDC channel. The electrical pulse signal is converted from an optical signal returning along an emitting optical path of the laser pulse sequence after the laser pulse sequence is reflected by an object.

### BRIEF DESCRIPTION OF THE DRAWINGS

FIG. 1 is a schematic diagram of a measured signal converted from an analog signal to a digital signal.

FIG. 2 is a schematic structural diagram of an example FPGA including a TDC channel.

FIG. 3 is a schematic diagram of a working mode of a TDC channel.

FIG. 4 is a schematic diagram of a correction method of an FPGA including a TDC channel.

FIG. 5 is a schematic flow chart of a time measurement correction method consistent with the embodiments of the present disclosure.

FIG. 6 is a schematic structural diagram of a time measurement correction system consistent with the embodiments of the present disclosure.

FIG. 7 is an example diagram of a gating method for a standard signal and a measured signal.

FIG. 8 is an example diagram of another gating method for a standard signal and a measured signal.

FIG. 9 is an example diagram of an implementation manner of the time measurement correction system shown in FIG. 6.

FIG. 10 is a schematic structural diagram of an FPGA consistent with the embodiments of the present disclosure.

FIG. 11 is a schematic structural diagram of a PCB consistent with the embodiments of the present disclosure.

FIG. 12 is a schematic structural diagram of a time measurement device according to an embodiment of the present disclosure.

FIG. 13 is a schematic structural diagram of a time measurement device according to another embodiment of the present disclosure.

FIG. 14 is a schematic structural diagram of a distance measurement device according to an embodiment of the present disclosure.

FIG. 15 is a schematic structural diagram of a distance measurement device according to another embodiment of the present disclosure.

FIG. 16 is a schematic structural diagram of a distance measurement device according to another embodiment of the present disclosure.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

To measure an object, a distance measurement device generally first transmits a distance measurement signal to a measured object. After the distance measurement signal is returned by the measured object, the returned signal (hereinafter referred to as a measured signal) can be received and measured by the TDC to calculate an arrival time (or receiving time) of the measured signal.

The measured signal received by the TDC can be a digital signal or an analog signal. The digital signal can be directly connected to the TDC for measurement, and the analog signal can be converted to a digital signal before entering the TDC for measurement.

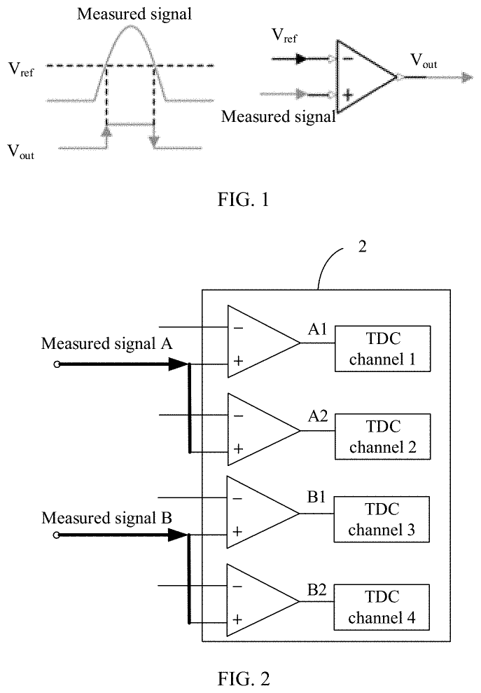

Taking the measured signal as an analog signal as an example. FIG. 1 is a schematic diagram of a measured signal converted from an analog signal to a digital signal. As shown in FIG. 1, the measured signal can be connected to a positive input terminal (i.e., an input terminal corresponds to a “+” sign) of a voltage comparator. A negative input terminal (i.e., the input terminal corresponding to a “−” sign) of the voltage comparator can be connected to a fixed reference voltage V_{ref}. When a voltage value of the measured signal exceeds the reference voltage V_{ref}, an output voltage Vₒᵤₜ of the voltage comparator is “1.” When the voltage value of the measured signal is lower than the reference voltage V_{ref}, the output voltage Vₒᵤₜ of the voltage comparator is “0.” Thereby, a conversion of the measured signal from an analog signal to a digital signal (a voltage waveform changes as shown on the left of FIG. 1) is completed. The voltage comparator can be implemented in many ways. For example, the voltage comparator can be implemented with a specific voltage comparison chip or through a differential input port of an FPGA.

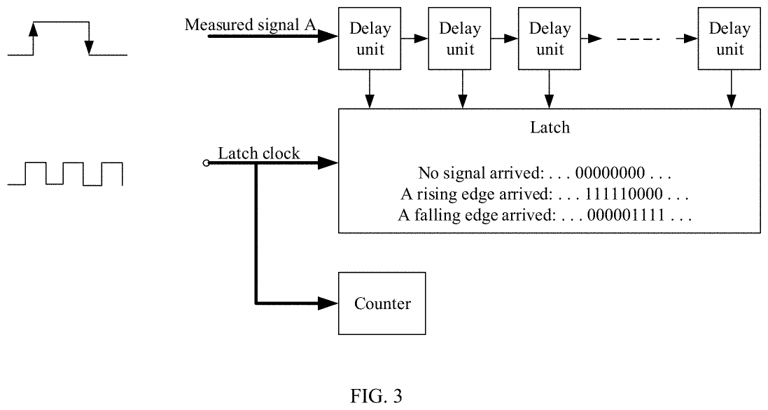

An FPGA-based TDC may include one or more TDC channels. Each TDC channel can be used for measurement of the measured signal independently. FIG. 2 is a schematic structural diagram of an example FPGA-based TDC. As shown in FIG. 2, FPGA 2 can receive two measured signals A and B. Each measured signal passes through a voltage comparator to generate two digital signals, that is, digital signals A1, A2, B1, and B2 shown in FIG. 3. The digital signals are then connected to the TDC channels 1, 2, 3, and 4 of FPGA 2 for measurement, respectively.

A working clock frequency of the FPGA generally ranges from a few hundred MHz to a few GHz. The FPGA uses simple clock counting to achieve nanosecond (ns)-level time measurement accuracy. To achieve a higher time measurement accuracy, time interpolation is often used to perform time measurement of the measured signal.

For example, a plurality of delay units can be set inside the FPGA. A delay time T_{d} of each of the plurality of delay units can range from a few picoseconds (ps) to hundreds of picoseconds. A delay chain can be formed by connecting the plurality of delay units. When the measured signal (refers to the digital signal entering the TDC channel, such as the digital signal A1, A2, B1 or B2 shown in FIG. 2) is transmitted on the delay chain, the measured signal can be sampled. An arrival time of the measured signal can be reversed by determining a position of the measured signal on the delay chain at a sampling time. Then, a high-precision time measurement in picoseconds can be achieved by incorporating with the clock counting of the FPGA. The following takes FIG. 3 as an example to illustrate a measurement manner of the arrival time of the measured signal.

FIG. 3 is a schematic diagram of a working mode of a TDC channel. As shown in FIG. 3, the measured signal is transmitted on the delay chain and is transmitted to a next delay unit after a period of time. An output state of the delay unit can indicate whether the measured signal passes through the delay unit. In addition, a latch clock can periodically latch a level state of the delay chain. A latch period is denoted as T_{CLK}. A number of cycles of the latch clock, that is, a simple clock count, which can also be called a coarse count.

If the measured signal does not arrive, the output state of the delay unit on the delay chain can all be “0,” and the output state of the delay chain is “ . . . 000000000 . . . .”

When a rising edge of the measured signal arrives, each time a delay unit is passed through, the output state of the delay unit becomes “1.” Because a propagation time of the delay chain is designed to be “slightly greater than one latch clock cycle,” there may be a certain latch time, that is, when the measured signal propagates on the delay chain. Then, the output state of the latch at the latch time is “ . . . 111110000 . . . ,” where a number of “1” indicates the position of the measured signal on the delay chain, which is called a fine count CF. The coarse count CC can be derived from a count of the latched clock at a same time.

If a falling edge of the measured signal is transmitted on the delay chain, the output state of the delay unit when the delay unit is passed through becomes “0.” The output state of the delay chain at another certain latch time is “ . . . 000001111 . . . ,” where the number of “0” indicates the position of the measured signal on the delay chain, which is called the fine count CC.

A final result of the time measurement can be calculated using a following formula: T=T_{CLK}*CC−T_{d}*CF. It can be seen from the above formula that an achievable accuracy of the time measurement manner of the FPGA-based TDC is determined by the latch clock T_{CLK} and the delay time T_{d} of the delay unit, but generally a magnitude of T_{CLK} is much larger than T_{d}. Therefore, a main factor of affects the time measurement accuracy is T_{d}.

However, in practical applications, due to limitations of physical factors, the delay time of each of the plurality of delay units in the delay chain cannot be guaranteed to be completely consistent. Factors that affect the delay unit may be one or more of the following factors: FPGA chip speed grade, on-chip location distribution of the delay unit, core operation voltage, ambient temperature, and hardware description language programming, etc.

To improve the time measurement accuracy, the time measurement accuracy of the TDC channel can be corrected. Further, when there are a plurality of TDC channels, a delay difference between the plurality of TDC channels can also be corrected. Then, a correction result can be used as an operation parameter of the TDC channel to compensate for an actual measurement process.

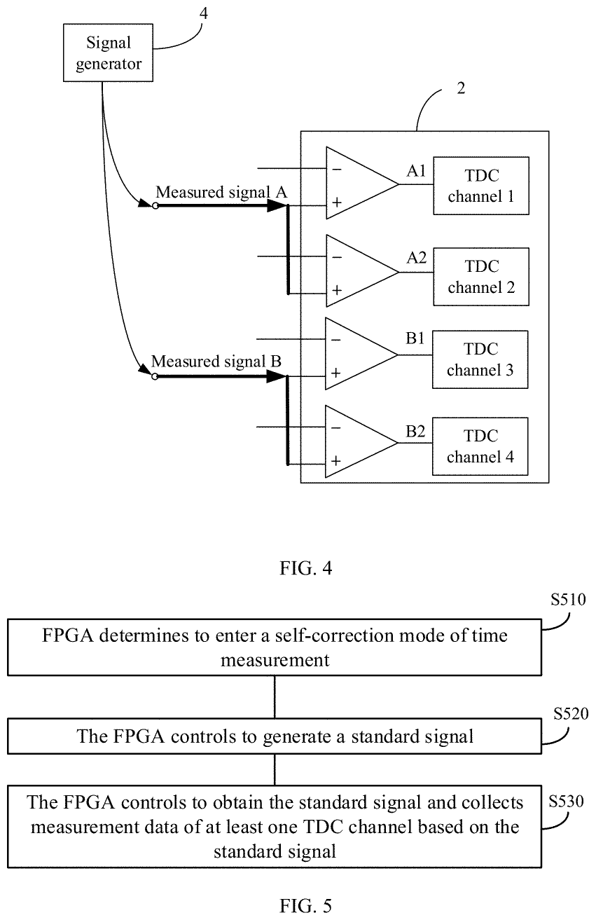

In the existing technologies, an external signal generator is generally used to correct each TDC channel when the FPGA is manufactured. Taking FIG. 4 as an example, an external signal generator 4 can generate a standard signal (or correction signal), transmit the standard signal to the FPGA 2 as measured signals A and B, and connect negative input terminals of all voltage comparators with a same fixed voltage, to enable the voltage comparator to convert the analog signals into digital signals at a same time.

Then, a TDC correction result can be obtained in a following manner.

(1) First, the time measurement accuracy of each TDC channel is analyzed based on the data collected by each TDC channel.

(2) Transmission paths of the standard signal to the four TDC channels are different. The arrival time of the standard signal measured by the four TDC channels are also different. A difference of the measured time represents the delay difference between the TDC channels. The correction result can be obtained by analyzing the difference of the measured time.

However, after the FPGA-based TDC is manufactured, the delay time T_{d} of the delay unit in the TDC channel may continue to change due to a long-term use (such as aging) of the electronic product or firmware upgrades. In this scenario, an original correction result may no longer be accurate. If the FPGA-based TDC is returned to the factory for re-correction, it may be time-consuming and labor-intensive. If the FPGA-based TDC is not corrected, the time measurement accuracy of the FPGA-based TDC may get worse and worse.

The time measurement correction method consistent with the embodiments of the present disclosure will be described in detail below.

FIG. 5 is a schematic flow chart of a time measurement correction method consistent with the embodiments of the present disclosure.

The method shown in FIG. 5 can be applied to FPGAs. At least one TDC channel is provided in the FPGA. The method shown in FIG. 5 can be executed by a control device of the FPGA. The method shown in FIG. 5 may include process S510 to process S530.

At S510, the FPGA determines to enter a self-correction mode of time measurement.

There are many ways to enter the self-correction mode. For example, the FPGA enters the self-correction mode when the FPGA determines that at least one of following conditions is met: when a correction system completes a program update, when a correction system is powered on and started, when the at least one TDC channel is idle, or when a correction time corresponding to a predetermined correction cycle is reached. In practice, a better matching self-correction mode can be selected for the FPGA according to application environments and specific requirements.

The subsequent processes S520 and S530 are executed by the FPGA in the self-correction mode.

At S520, the FPGA controls to generate a standard signal.

The standard signal (or correction signal) can be used to correct the at least one TDC channel of the FPGA. The standard signal may include a signal with known parameters, for example, at least one of a square wave, a triangle wave, a sawtooth wave, or a trapezoidal wave.

A number of standard signals generated by the FPGA is not limited here. For example, the FPGA can control to generate at least one standard signal one-to-one corresponding to the at least one TDC channel. Each standard signal is used to correct the corresponding TDC channel. Alternately, the FPGA can control to generate a unique standard signal. The unique standard signal is used to correct each of the at least one TDC channel of the FPGA.

At S530, the FPGA controls to obtain a standard signal and collects measurement data of the at least one TDC channel based on the standard signal.

The measurement data can include a coarse count and a fine count obtained by the TDC channel during a correction process. The coarse count can be used to indicate a number of cycles of a latch clock inside the FPGA. The fine count can be used to indicate a position of an actually measured signal in a delay chain of the TDC channel. For the detailed description of the coarse count and fine count, reference may be made to the description of those shown in FIG. 3, which is omitted here.

The FPGA consistent with the embodiments of the present disclosure can control to generate the standard signal to self-correct the TDC channel of the FPGA, thereby improving the time measurement accuracy of the FPGA. Because the FPGA adopts a self-correction solution, the FPGA can be recorrected at any time before or after manufactured, which is easy to operate and highly automated, thereby greatly reducing difficulty of the correction of the TDC channel of the FPGA and improving the feasibility of the correction solution.

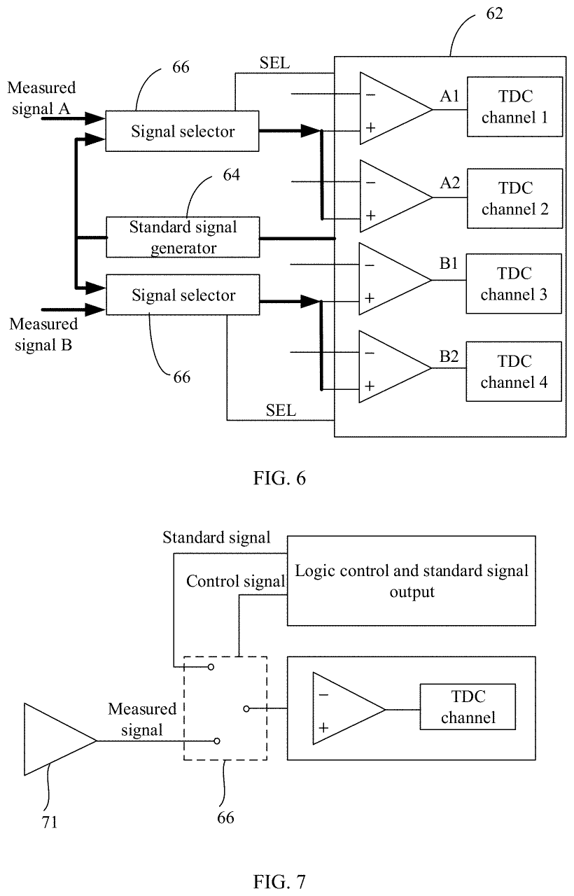

Process S520 can be implemented in multiple ways. For example, the FPGA can generate the standard signal. FIG. 6 is a schematic structural diagram of a time measurement correction system consistent with the embodiments of the present disclosure. For another example, as shown in FIG. 6, an external standard signal generator 64 can be controlled by an FPGA 62 to generate the standard signal.

In some embodiments, as a first implementation manner, the FPGA 62 may send a generation instruction to the standard signal generator 64. The generation instruction can be used to instruct the standard signal generator 64 to generate the standard signal.

In some embodiments, as a second implementation manner, the FPGA 62 may input an output signal to the standard signal generator 64 and control the standard signal generator 64 to convert the output signal into the standard signal.

A difference between the first implementation manner and the second implementation manner is that the standard signal generator 64 generates the standard signal independently and the FPGA 62 is mainly used to trigger the standard signal generator 64 to work in the first implementation manner, while in addition to triggering the standard signal generator 64 to work, the FPGA 62 also provides the standard signal generator 64 with an initial signal (i.e., the output signal of the FPGA 62) to be converted into the standard signal in the second implementation manner, which can simplify the implementation of the standard generator 64.

The standard signal generator 64 may include an analog circuit, or a digital-to-analog converter, or a combination of the analog circuit and the digital-to-analog converter, which is not limited here.

The standard signal generator 64 and the FPGA 62 may be integrated on a same printed circuit board (PCB). The FPGA 62 and the standard signal generator 64 consistent with the embodiments of the present disclosure can replace a signal generator used by a correction personnel in the related technology when the FPGA is manufactured, thereby realizing the self-correction of the TDC.

Process S530 can be implemented in multiple ways. As shown in FIG. 6, a signal selector 66 can be provided outside the FPGA. The signal selector 66 can gate the standard signal into the FPGA. The signal selector 66 may include any unit with a signal gating function, for example, an analog switch or a multiplexer, which is not limited here. The standard signal generator 66 can be integrated with the FPGA 62 on the same PCB. The FPGA 62 may send a strobe signal (SEL) to the signal selector 66 to select between the measured signal and the standard signal.

FIG. 7 is an example diagram of a gating method for a standard signal and a measured signal. An operational amplifier 71 shown in FIG. 7 can be used to output the actually measured signal. The signal gating unit 66 may include an analog switch, which selects the measured signal or the standard signal under the control of the control signal. For the realization of functions such as logic control and standard signal output in FIG. 7, reference may be made to the above description, which is not limited here.

In some embodiments, a specific signal selector may not be provided to select the signal, but the signal selection is achieved by controlling the state of the output of the measured signal and/or the output of the standard signal.

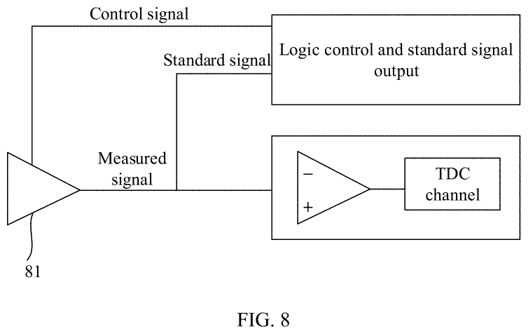

FIG. 8 is an example diagram of another gating method for a standard signal and a measured signal. Taking FIG. 8 as an example, when the FPGA enters the self-correction mode, the FPGA can set an output of an operational amplifier 81 from an enable state to a high-impedance state, and set an output of a standard signal output module (not shown in FIG. 8) from a high-impedance state to an enable state, to obtain the standard signal. When the FPGA enters a working mode, the FPGA can set the output of the operational amplifier 81 from the high-impedance state to the enable state, and set the output of the standard signal output from the enable state to the high-impedance state, to measure the actually measured signal.

As described above, after process S530, the FPGA can obtain the measurement data. After the measurement data is obtained, an analysis of the measurement data can be performed online or offline, which is not limited here.

As an example, the method of FIG. 5 may further include in the self-correction mode, the FPGA calculating correction data according to the measurement data and updating the correction data to the TDC channel. That is, the correction data can be calculated by the FPGA itself.

As another example, the method shown in FIG. 5 may further include in the self-correction mode, the FPGA sending the measurement data to an offline unit to enable the offline unit to calculate the correction data according to the measurement data, and the FPGA receiving the correction data sent by the offline unit and updating the correction data to the TDC channel. The offline unit can include a specific computer or a specific software analysis unit.

The correction data may include delay size correction data of the delay unit in the TDC channel. When at least two TDC channels are provided in the FPGA, the correction data may also include correction data of a delay difference between any two TDC channels of the at least two TDC channels. In an example embodiment, the method shown in FIG. 5 may further include the FPGA correcting the at least two TDC channels according to the correction data.

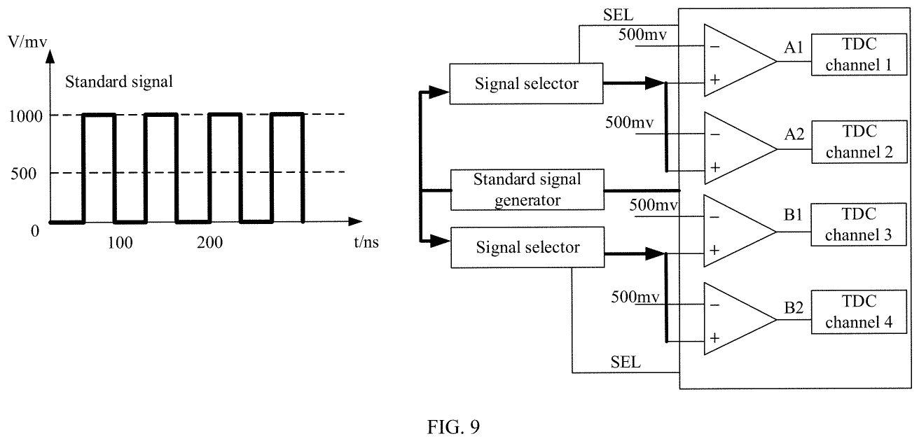

An example of the FPGA correction process is given below in conjunction with FIG. 9.

FIG. 9 shows the correction process using a 10 MHz square wave as the standard signal. First, the standard signal generator can generate a continuous square wave with a duty cycle of 50%, an amplitude of 0-1 V, and a frequency of 10 MHz. Then, the FPGA can be switched to the self-correction mode. The standard signal is selected as the input signal of the FPGA. The reference voltages of the four voltage comparators are set to a same value, for example, 500 mV, simultaneously.

Theoretically, the input signals and reference voltages of the four TDC channels are the same, and the arrival time T_{A1}˜T_{B2} of the measured standard signals are also supposed to be the same. However, in practice, due to the influence of some factors, differences among T_{A1}˜T_{B2} are not avoidable. A difference value can be obtained by repeatedly measurement of the same standard signal many times. The difference value is recorded and compensated in a normal measurement process, therefore the delay difference between the TDC channels can be corrected.

Take TDC channel 1 as an example. First, a large number of the measurement data of TDC channel 1 can be collected (e.g., collecting more than 10,000 times). A statistical analysis can be performed on the coarse and fine counts in the measurement data to obtain a maximum number N₁ of the delay units that can be reached by the delay chain in TDC channel 1. According to a working principle of the TDC channel, T_{CLK}=N₁*T_{d1}, the delay time T_{d1} of the delay unit on the TDC channel 1 can be obtained. The delay time T_{d1} is applied to the normal measurement process of the TDC channel 1, therefore the time measurement accuracy of TDC channel 1 can be corrected.

In addition to the self-correction mode, FPGA can also enter the working mode. In the working mode, FPGA can measure the time of the measured signal. For example, in the working mode, FPGA can control a transmitter to emit laser pulse sequence. The FPGA can receive an electrical pulse signal. The electrical pulse signal is converted from an optical signal returning along an emitting optical path of the laser pulse sequence after the optical pulse sequence is reflected by an object. The FPGA measure the time of the electrical pulse signal through the TDC channel.

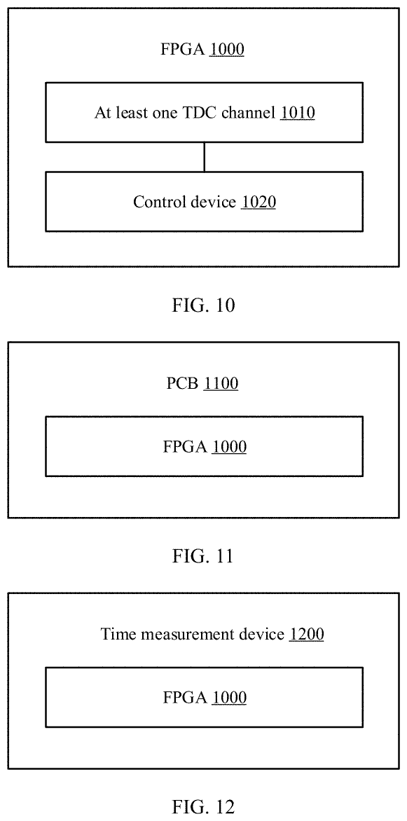

The method embodiments of the present disclosure are described in detail above with reference to FIGS. 1 to 9, and the device embodiments of the present disclosure are described in detail below with reference to FIG. 10. It should be understood that the description of the method embodiments and the description of the device embodiments correspond to each other, and therefore, the parts that are not described in detail may refer to the above method embodiments.

An FPGA consistent with the embodiments of the disclosure is also provided. FIG. 10 is a schematic structural diagram of an FPGA consistent with the embodiments of the present disclosure. As shown in FIG. 10, the FPGA 1000 includes at least one TDC channel 1010 and a control device 1020.

The control device 1020 can be used to perform the following operations: determining that the FPGA 1000 enters a self-correction mode of time measurement, in the self-correction mode, controlling to generate a standard signal, and controlling the FPGA to obtain the standard signal and collect measurement data of the at least one TDC channel based on the standard signal. The standard signal is used to correct at least one TDC channel of the FPGA 1000.

In some embodiments, determining that the FPGA 1000 enters the self-correction mode of time measurement may include the FPGA 1000 entering the self-correction mode when the FPGA 1000 determines that at least one of the following conditions is met: when a correction system completes a program update, when a correction system is powered on and started, when the at least one TDC channel is idle, or when a correction time corresponding to a predetermined correction cycle is reached.

In some embodiments, controlling to generate the standard signal may include controlling to generate at least one standard signal one-to-one corresponding to the at least one TDC channel. Each standard signal is used to correct the corresponding TDC channel. Alternately, controlling to generate the standard signal may include controlling to generate a unique standard signal, and the unique standard signal is used to correct each of the at least one TDC channel of the FPGA 1000.

In some embodiments, controlling to generate the standard signal may include controlling a signal generator of the FPGA 1000 to generate the standard signal.

In some embodiments, controlling to generate the standard signal may include controlling a standard signal generator other than the FPGA 1000 to generate the standard signal.

In some embodiments, controlling the standard signal generator other than the FPGA 1000 to generate the standard signal may include sending a generation instruction to the standard signal generator, and the generation instruction is used to instruct the standard signal generator to generate the standard signal.

In some embodiments, controlling the standard signal generator other than the FPGA 1000 to generate the standard signal may include inputting an output signal to the standard signal generator and controlling the standard signal generator to convert the output signal into the standard signal.

In some embodiments, the standard signal generator may include at least one of an analog circuit, a digital-to-analog converter, or a combination of the analog circuit and the digital-to-analog converter.

In some embodiments, the standard signal may include at least one of a square wave, a triangle wave, a sawtooth wave, or a trapezoidal wave.

In some embodiments, controlling the FPGA to obtain the standard signal may include controlling a signal selector to select the standard signal to enter the FPGA 1000.

In some embodiments, the signal selector includes an analog switch or a multiplexer.

In some embodiments, the FPGA 1000 may further include a first processing unit configured to calculate correction data according to the measurement data in the self-correction mode and update the correction data to the TDC channel.

In some embodiments, the FPGA 1000 may further include a second processing unit configured to send the measurement data to an offline unit to enable the offline unit to calculate correction data according to the measurement data, and receive the correction data sent by the offline unit and update the correction data to the TDC channel.

In some embodiments, the correction data includes correction data of a delay size of a delay unit in the TDC channel.

In some embodiments, at least two TDC channels are provided in the FPGA 1000. The FPGA 1000 may further include a correction unit. In the self-correction mode, the at least two TDC channels are corrected, and the correction data includes correction data of a delay difference between any two TDC channels of the at least two TDC channels.

In some embodiments, the measurement data includes a coarse count and a fine count obtained by the TDC channel during a correction process.

In some embodiments, the coarse count is used to indicate a number of cycles of a latch clock inside the FPGA 1000.

In some embodiments, the fine count is used to indicate a position of an actually measured signal in a delay chain of the TDC channel.

In some embodiments, controlling the FPGA to obtain the standard signal may include setting an output of an operational amplifier from an enable state to a high-impedance state, and setting an output of a standard signal output module from a high-impedance state to an enable state, to obtain the standard signal. The operational amplifier is used to output the actually measured signal.

In some embodiments, the control device 1020 can also be used to perform the following operations: setting the output of the operational amplifier from the high-impedance state to the enable state, and setting the output of the standard signal output from the enable state to the high-impedance state, to measure the actually measured signal.

In some embodiments, the control device 1020 can also be used to perform the following operations: after entering the working mode, controlling a transmitter to emit a laser pulse sequence. The TDC channel is used to perform time measurement on an electrical pulse signal after the receiver receives the electrical pulse signal. The electrical pulse signal is converted from an optical signal returning along an emitting optical path of the laser pulse sequence after the laser pulse sequence being reflected by an object.

A PCB consistent with the embodiments of the present disclosure is also provided. FIG. 11 is a schematic structural diagram of a PCB 1100 consistent with the embodiments of the present disclosure. As shown in FIG. 11, the PCB 1100 includes the above-described FPGA 1000.

In some embodiments, the PCB 1100 may further include a standard signal generator. The standard signal generator is used to receive a generation instruction sent by the FPGA and generate a standard signal according to the generation instruction.

In some embodiments, the PCB 1100 may further include the standard signal generator used to use an output signal of the FPGA as an input and convert the output signal into the standard signal.

In some embodiments, the standard signal generator may include at least one of an analog circuit, a digital-to-analog converter, or a combination of the analog circuit and the digital-to-analog converter.

In some embodiments, the PCB 1100 may further include a signal selector used to gate the standard signal into the FPGA.

In some embodiments, the signal selector includes an analog switch or a multiplexer.

In some embodiments, the PCB 1100 may further include an offline unit used to receive the measurement data of the FPGA, calculate correction data according to the measurement data, and send the correction data to the FPGA.

A time measurement device consistent with the embodiments of the present disclosure is also provided. FIG. 12 is a schematic structural diagram of a time measurement device 1200 according to an embodiment of the present disclosure. As shown in FIG. 12, the time measurement device 1200 includes the above-described FPGA 1000.

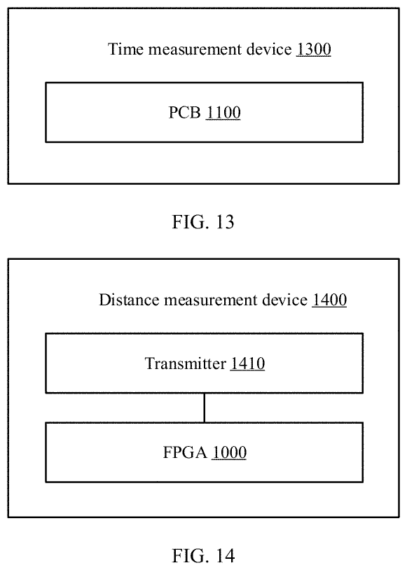

Another time measurement device consistent with the embodiments of the present disclosure is also provided. FIG. 13 is a schematic structural diagram of a time measurement device 1300 according to another embodiment of the present disclosure. As shown in FIG. 13, the time measurement device 1300 includes the above-described PCB 1100.

A distance measurement device consistent with the embodiments of the present disclosure is also provided. FIG. 14 is a schematic structural diagram of a distance measurement device 1400 according to an embodiment of the present disclosure. As shown in FIG. 14, the distance measurement device 1400 includes a transmitter 1410 and the FPGA 1000 described above.

The transmitter 1410 can be used to emit a laser pulse sequence.

The FPGA 1000 can be used to control the laser pulse sequence emitted by the transmitter. The FPGA 1000 can also be used to receive an electrical pulse signal. The electrical pulse signal is converted from an optical signal returning along an emitting optical path of the laser pulse sequence after the laser pulse sequence is reflected by an object. The FPGA 1000 may also be used to perform time measurement on the electrical pulse signal through the at least one TDC channel.

In some embodiments, the distance measurement device 1400 may further include a scanner. The scanner may be used to change a transmission direction of the laser pulse signal and then emit it. The laser pulse signal reflected by the object passes through the scanner and then enters a laser receiver.

In some embodiments, the scanner further includes a driver and a prism with uneven thickness. The driver is used to drive the prism to rotate to enable the laser pulse signal passing through the prism to be emitted in different directions.

In some embodiments, the scanner further includes two drivers and two parallel prisms with uneven thickness. The two drivers are used to drive the two prisms to rotate in opposite directions. The laser pulse signal of the transmitter passes through the two prisms in sequence. The transmission direction of the laser pulse signal is then changed before the laser pulse signal is emitted.

The distance measurement device 1400 may include an electronic device, for example, a laser radar or a laser distance measurement device. In an example embodiment, the distance measurement device is used to sense external environmental information, for example, distance information, orientation information, reflection intensity information, speed information, etc. of environmental targets. In an implementation manner, the distance measurement device can detect a distance from a probe to the distance measurement device by time measurement of light propagation between the distance measurement device and the probe, that is, a time-of-flight (TOF). Alternatively, the distance measurement device can also use other technologies to detect the distance from a detected object to the distance measurement device, such as a distance measurement method based on phase shift measurement or a distance measurement method based on frequency shift measurement, which is not limited here.

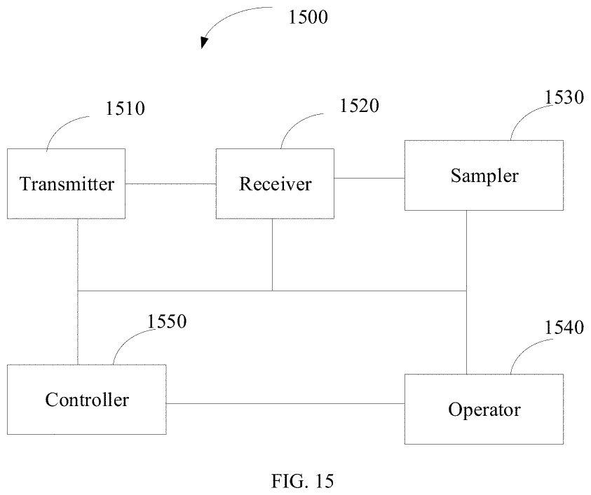

For ease of understanding, a working process of distance measurement will be described with an example in conjunction with the distance measurement device 1500 shown in FIG. 15.

As shown in FIG. 15, the distance measurement device 1500 may include a transmitter 1510, a receiver 1520, a sampler 1530, and an operator 1540. Any one or more of the transmitter 1510, the receiver 1520, the sampler 1530, and the operator 1540 can be implemented in a form of a circuit.

The transmitter 1510 may emit a light pulse sequence (for example, a laser pulse sequence). The receiver 1520 can receive the light pulse sequence reflected by an object to be detected and perform photoelectric conversion on the light pulse sequence to obtain an electrical signal. After the electrical signal is processed, the electrical signal can be output to the sampler 1530. The sampler 1530 may sample the electrical signal to obtain a sampling result. The operator 1540 may determine a distance between the distance measurement device 1500 and the detected object based on the sampling result of the sampler 1530.

In some embodiments, the distance measurement device 1500 may further include a controller 1550, which can control other circuits, for example, can control a working time of each circuit and/or set parameters for each circuit. The controller 1550 can also be implemented in a form of a circuit.

It should be understood that although the distance measurement device shown in FIG. 15 includes one transmitter, one receiver, one sampler, and one operator for emitting a beam for detection, the embodiments of the present disclosure are not limited here. A number of any one of the transmitter, the receiver, the sampler, and the operator can also be at least two, which are used to emit at least two light beams in a same direction or in different directions. The at least two light beams can be emitted simultaneously or be emitted at different times. In an example embodiment, light-emitting chips in the at least two transmitters are packaged in the same unit. For example, each of the transmitters includes a laser-emitting chip, and dies in the laser-emitting chips in the at least two transmitters are packaged together and housed in a same packaging space.

In some embodiments, in addition to the circuits shown in FIG. 15, the distance measurement device 1500 may further include a scanner 1560 for changing the propagation direction of the at least one laser pulse sequence emitted by the transmitter.

A unit including the transmitter 1510, the receiver 1520, the sampler 1530, and the operator 1540, or a unit including the transmitter 1510, the receiver 1520, the sampler 1530, the operator 1540, and the controller 1550 may be referred to as a distance measurement unit. The distance measurement unit can be independent of other units, for example, the scanner.

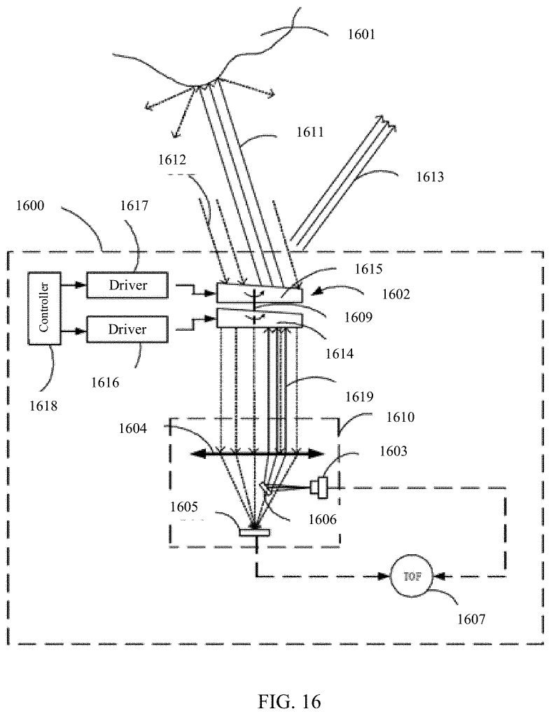

A coaxial optical path can be used in the distance measurement device, that is, a light beam emitted by the distance measurement device and a reflected light beam share at least part of the optical path in the distance measurement device. For example, after the at least one laser pulse sequence emitted by the transmitter changes its propagation direction and exits through the scanner, a laser pulse sequence reflected by the probe passes through the scanner and then enters the receiver. Alternatively, an off-axis optical path can be used in the distance measurement device, that is, the light beam emitted by the distance measurement device and the reflected light beam are transmitted along different optical paths in the distance measurement device, respectively. FIG. 16 shows a schematic diagram of a distance measurement device using the coaxial optical path according to an embodiment of the present disclosure.

The distance measurement device 1600 includes a distance measurement unit 1610, which includes a transmitter 1603 (which may include the above-described transmitter), a collimator 1604, a detector 1605 (which may include the above-described receiver, sampler, and operator) and a light path adjustor 1606. The distance measurement unit 1610 is used to emit a light beam, receive a reflected light, and convert the reflected light into an electrical signal. The transmitter 1603 can be used to transmit a light pulse sequence. In an example embodiment, the transmitter 1603 may emit a laser pulse sequence. In some embodiments, the laser beam emitted by the transmitter 1603 is a narrow-bandwidth beam with a wavelength outside the visible light range. The collimator 1604 is arranged on an exit light path of the transmitter 1603 and is used collimate the light beam emitted from the transmitter 1603 into parallel light and output to the scanner. The collimator is also used to condense at least a part of the reflected light reflected by the probe. The collimator 1604 may include a collimating lens or another member capable of collimating light beams.

In an example embodiment shown in FIG. 16, a transmission light path and a reception light path in the distance measurement device are combined before the collimator 1604 through the light path adjustor 1606 to enable the transmission light path and the reception light path can share a same collimator, thereby causing the light path more compact. In some embodiments, the transmitter 1603 and the detector 1605 may use collimators thereof, respectively. The optical path adjustor 1606 is arranged on the optical path after the collimators.

In an example embodiment shown in FIG. 16, because a beam aperture of the beam emitted by the transmitter 1603 is relatively small, and a beam aperture of the reflected light received by the distance measurement device is relatively large, the optical path adjustor can use a small-area reflector to combine the transmission light path and the reception light path. In some embodiments, the light path adjustor may also use a reflector with a through hole. The through hole is used to transmit the emitted light of the transmitter 1603. The reflector is used to reflect the reflected light to the detector 1605. Therefore, shielding of back light by the support of the small reflector when the small reflector is used can be reduced.

In an example embodiment shown in FIG. 16, the optical path adjustor is deviated from an optical axis of the collimator 1604. In some embodiments, the optical path adjustor may also be located on the optical axis of the collimator 1604.

The distance measurement device 1600 may further include a scanner 1602. The scanner 1602 is placed on the exit light path of the distance measurement unit 1601. The scanner 1602 is used to change the transmission direction of a collimated beam 1619 emitted by the collimator 1604 and project it to external environment, and project the reflected light to the collimator 1604. The reflected light is collected on the detector 1605 via the collimator 1604.

In an example embodiment, the scanner 1602 may include at least one optical element for changing the propagation path of the light beam. The optical element may be used to change the propagation path of the light beam by reflecting, refracting, or diffracting the light beam. For example, the scanner 1602 includes a lens, a mirror, a prism, a galvanometer, a grating, a liquid crystal, an optical phased array, or any combination of the above optical elements. In an example embodiment, at least part of the optical element is movable, for example, the at least part of the optical element is driven to move by a driver. The movable optical element can reflect, refract, or diffract the light beam to different directions at different times. In some embodiments, a plurality of optical elements of the scanner 1602 can rotate or vibrate around a common axis 1609. Each rotating or vibrating optical element is used to continuously change the propagation direction of an incident light beam. In an example embodiment, the plurality of optical elements of the scanner 1602 may rotate at different speeds or vibrate at different speeds. In another example embodiment, at least part of the optical elements of the scanner 1602 may rotate at substantially a same rotation speed. In some embodiments, the plurality of optical elements of the scanner 1602 may also rotate around different axes. In some embodiments, the plurality of optical elements of the scanner 1602 may also rotate in a same direction, rotate in different directions, vibrate in a same direction, or vibrate in different directions, which are not limited here.

In an example embodiment, the scanner 1602 includes a first optical element 1614 and a driver 1616 connected to the first optical element 1614. The driver 1616 is used to drive the first optical element 1614 to rotate around the rotation axis 1609 to enable the first optical element 1614 to change a direction of the collimated beam 1619. The first optical element 1614 projects the collimated beam 1619 to different directions. In an example embodiment, an angle between the direction of the collimated light beam 1619 changed by the first optical element and the rotation axis 1609 changes with the rotation of the first optical element 1614. In an example embodiment, the first optical element 1614 includes a pair of opposed non-parallel surfaces through which the collimated light beam 1619 passes. In an example embodiment, the first optical element 1614 includes a prism whose thickness varies in at least one radial direction. In an example embodiment, the first optical element 1614 includes a wedge angle prism to collimate the beam 1619 for refracting.

In an example embodiment, the scanner 1602 further includes a second optical element 1615. The second optical element 1615 rotates around the rotation axis 1609. A rotation speed of the second optical element 1615 is different from a rotation speed of the first optical element 1614. The second optical element 1615 is used to change the direction of the light beam projected by the first optical element 1614. In an example embodiment, the second optical element 1615 is connected to another driver 1617. The driver 1617 drives the second optical element 1615 to rotate. The first optical element 1614 and the second optical element 1615 can be driven by a same or different drivers, to cause the rotation speeds and/or rotation directions of the first optical element 1614 and the second optical element 1615 are different, thereby causing the collimated light beam 1619 to be projected to an outside space in different directions and achieving a relatively large scanning space. In an example embodiment, the controller 1618 controls the drivers 1616 and 1617 to drive the first optical element 1614 and the second optical element 1615, respectively. The rotational speeds of the first optical element 1614 and the second optical element 1615 can be determined according to a desired scanning area and pattern in actual applications. The drivers 1616 and 1617 may include motors.

In an example embodiment, the second optical element 1615 includes a pair of opposed non-parallel surfaces through which the light beam passes. In an example embodiment, the second optical element 1615 includes a prism whose thickness varies in at least one radial direction. In an example embodiment, the second optical element 1615 includes a wedge angle prism.

In an example embodiment, the scanner 1602 further includes a third optical element (not shown) and a driver for driving the third optical element to move. In some embodiments, the third optical element may include a pair of opposite non-parallel surfaces. The light beam passes through the pair of surfaces. In an example embodiment, the third optical element may include a prism whose thickness varies in at least one radial direction. In an example embodiment, the third optical element may include a wedge prism. At least two of the first optical element, the second element, and the third optical element rotate at different rotation speeds and/or in different rotation directions.

The rotation of each optical element of the scanner 1602 can project light to different directions, such as directions 1611 and 1613, to cause a space around the distance measurement device 1600 to be scanned. When the light 1611 projected by the scanner 1602 hits a detection object 1601, a part of the light is reflected by the detection object 1601 to the distance measurement device 1600 in a direction opposite to the projected light 1611. The reflected light 1612 reflected by the detection object 1601 passes through the scanner 1602 and then enters the collimator 1604.

The detector 1605 and the transmitter 1603 are placed on a same side of the collimator 1604. The detector 1605 is used to convert at least part of the reflected light passing through the collimator 1604 into electrical signals.

In an example embodiment, an anti-reflection film is plated on each optical element. In some embodiments, a thickness of the anti-reflection film is equal to or close to a wavelength of the light beam emitted by the transmitter 1603, which can increase an intensity of the transmitted light beam.

In an example embodiment, a filter layer is plated on a surface of a member located on the beam propagation path in the distance measurement device, or a filter is provided on the beam propagation path for transmitting at least a wavelength band of the beam emitted by the transmitter and reflecting other bands, to reduce a noise caused by ambient light to the receiver.

In some embodiments, the transmitter 1603 may include a laser diode through which nanosecond laser pulses are emitted. Further, a laser pulse receiving time can be determined, for example, the laser pulse receiving time can be determined by detecting a rising edge time and/or a falling edge time of the electrical signal pulse. Therefore, the distance measurement device 1600 can calculate the TOF using pulse receiving time information and pulse sending time information to determine a distance between the probe 1601 and the distance measurement device 1600.

A distance and azimuth detected by the distance measurement device 1600 can be used for remote sensing, obstacle avoidance, surveying and mapping, modeling, navigation, etc. In an example embodiment, the distance measurement device can be applied to a mobile platform. The distance measurement device can be mounted at a platform body of the mobile platform. The mobile platform with the distance measurement device can measure external environments, for example, measurement a distance between the mobile platform and obstacles for obstacle avoidance and for two-dimensional or three-dimensional surveying and mapping of the external environments. In some embodiments, the mobile platform includes at least one of an unmanned aerial vehicle, a car, a remote control car, a robot, or a camera. When the distance measurement device is applied to the unmanned aerial vehicle, the platform body includes a fuselage of the unmanned aerial vehicle. When the distance measurement device is applied to a car, the platform body includes a body of the car. The car can be a self-driving car or a semi-self-driving car, which is not limited here. When the distance measurement device is applied to a remote-control car, the platform body includes a body of the remote-control car. When the distance measurement device is applied to a robot, the platform body includes the robot. When the distance measurement device is applied to a camera, the platform body includes the camera.

It should be understood that a division of circuits, sub-circuits, and sub-units in each embodiment of the present disclosure is only illustrative. A person of ordinary skill in the art may be aware that the circuits, sub-circuits, and sub-units of the examples described in the embodiments disclosed herein can be further divided or combined.

The method or device described in the above embodiments may be implemented in whole or in part by software, hardware, firmware, or any combination thereof. When the method or device is implemented by software, it can be implemented in a form of a computer program product in whole or in part. The computer program product includes one or more computer instructions. When the one or more computer instructions are loaded and executed on the computer, the processes or functions according to the embodiments of the present disclosure are performed in whole or in part. The computer can include a general-purpose computer, a special-purpose computer, a computer network, or another programmable device. The one or more computer instructions can be stored in a computer-readable storage medium or transmitted from one computer-readable storage medium to another computer-readable storage medium. For example, the one or more computer instructions can be transmitted from a website, computer, server, or data center through a cable (e.g., a coaxial cable, an optical fiber, a digital subscriber line (DSL)) or a wireless manner (e.g., infrared, wireless, microwave, etc.) to another website, computer, server, or data center. The computer-readable storage medium may be any suitable medium that can be accessed by a computer, or a data storage device, such as a server or data center integrated with one or more suitable medium. The medium may include a magnetic medium (e.g., a floppy disk, a hard drive, a tape), an optical medium (e.g., a high-density digital video disk (DVD)), or a semiconductor medium (e.g., a solid-state disk (SSD)).

The term “an example embodiment” mentioned throughout the specification means that a specific feature, structure, or characteristic related to an example embodiment is included in at least one embodiment of the present disclosure. Therefore, the appearances of “in an example embodiment” in various places throughout the specification do not necessarily refer to a same embodiment. In addition, these specific features, structures, or characteristics can be combined in one or more embodiments in any suitable manner.

In the various embodiments of the present disclosure, a sequence number of the above-described processes does not mean an order of execution, and the execution order of each process should be determined by its function and internal logic and should not correspond to the embodiments of the present disclosure, which is not limited here.

In the embodiments of the present disclosure, “B corresponding to A” means that B is associated with A, and B can be determined according to A. However, it should also be understood that determining B based on A does not mean that B is determined only based on A, and B can also be determined based on A and/or other information.

The term “and/or” herein is only an association relationship describing the associated objects, indicating that there can be three types of relationships. For example, A and/or B, which can refer to three cases: A exists alone, both A and B exist, and B exists alone. In addition, the character “/” herein generally indicates that the associated objects before and after are in an “or” relationship.

A person of ordinary skill in the art may realize that the units and algorithm steps of the examples described in combination with the embodiments disclosed herein can be implemented by electronic hardware or a combination of computer software and electronic hardware. Whether these functions are executed by hardware or software depends on the specific application and design constraint conditions of the technical solution. Those skilled in the art can use different methods for each specific application to implement the described functions, but such implementation should not be considered beyond the scope of the present disclosure.

Those skilled in the art can clearly understand that, for the convenience and conciseness of description, the specific working process of the system, device, and unit described above can refer to the corresponding process in the above-described method embodiments, which will not be repeated here.

The disclosed system, device, and method may be implemented in other manners. For example, the device embodiments described above are merely illustrative. For example, the division of the units is only a logical function division, and there may be other divisions in actual implementation. For example, multiple units or components may be combined or can be integrated into another system, or some features can be ignored or not implemented. In addition, the mutual coupling or direct coupling or communication connection may be indirect coupling or communication connection through some interfaces, devices, or units, and may be in electrical, mechanical, or other forms.

The units described as separate components may or may not be physically separated. The components displayed as units may or may not be physical units, that is, they may be located in one place, or may be distributed on multiple network units. Some or all of the units may be selected according to actual needs to achieve the objectives of the solutions of the embodiments.

In addition, the functional units in the various embodiments of the present disclosure may be integrated into one processing unit, or each unit may exist alone physically, or two or more units may be integrated into one unit.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A time measurement correction method comprising:
a field programmable gate array (FPGA) determining to enter a self-correction mode of time measurement, the FPGA including at least one time-to-digital conversion (TDC) channel; and
in the self-correction mode:
the FPGA controlling to generate a standard signal, the standard signal being configured to correct the at least one TDC channel of the FPGA; and
the FPGA controlling to obtain the standard signal and collecting measurement data of the at least one TDC channel based on the standard signal.

2. The method of claim 1, wherein the FPGA determining to enter the self-correction mode of the time measurement includes:
the FPGA entering the self-correction mode in response to determining at least one of:
a correction system completes a program update;
the correction system is powered on to start;
the at least one TDC channel is idle; or
a correction time corresponding to a predetermined correction cycle is reached.

3. The method of claim 1, wherein the FPGA controlling to generate the standard signal includes:
the FPGA controlling to generate at least one standard signal one-to-one corresponding to the at least one TDC channel, each of the at least one standard signal being configured to correct a corresponding TDC channel; or
the FPGA controlling to generate one standard signal, the one standard signal being configured to correct each of the at least one TDC channel of the FPGA.

4. The method of claim 1, wherein the FPGA controlling to generate the standard signal includes:
the FPGA generating the standard signal.

5. The method of claim 1, wherein the FPGA controlling to generate the standard signal includes:
the FPGA controlling a standard signal generator to generate the standard signal.

6. The method of claim 5, wherein the FPGA controlling the standard signal generator to generate the standard signal includes:
the FPGA sending a generation instruction to the standard signal generator, the generation instruction being configured to instruct the standard signal generator to generate the standard signal.

7. The method of claim 5, wherein the FPGA controlling the standard signal generator to generate the standard signal includes:
the FPGA inputting an output signal to the standard signal generator and controlling the standard signal generator to convert the output signal into the standard signal.

8. The method of claim 5, wherein the standard signal generator includes at least one of an analog circuit, a digital-to-analog converter, or a combination of the analog circuit and the digital-to-analog converter.

9. The method of claim 1, in the self-correction mode, further comprising:
the FPGA calculating and obtaining correction data according to the measurement data and updating the correction data to the at least one TDC channel.

10. The method of claim 9, wherein the correction data includes correction data of a delay size of a delay unit in the TDC channel.

11. The method of claim 9, wherein:
at least two TDC channels are provided in the FPGA; and
the method further includes, in the self-correction mode:
the FPGA correcting the at least two TDC channels, the correction data including correction data of a delay difference between two TDC channels of the at least two TDC channels.

12. The method of claim 1, further comprising, in the self-correction mode:
the FPGA sending the measurement data to an offline unit to enable the offline unit to calculate and obtain correction data according to the measurement data; and
the FPGA receiving the correction data sent by the offline unit and updating the correction data to the at least one TDC channel.

13. The method of claim 1, wherein the measurement data includes a coarse count and a fine count obtained by the at least one TDC channel during correction.

14. The method of claim 13, wherein the coarse count is configured to indicate a number of cycles of a latch clock inside the FPGA.

15. The method of claim 13, wherein the fine count is configured to indicate a position of an actually measured signal in a delay chain of the at least one TDC channel.

16. The method of claim 1, wherein the FPGA controlling to obtain the standard signal includes:
the FPGA setting an output of an operational amplifier from an enable state to a high-impedance state and setting an output of a standard signal output module from a high-impedance state to an enable state, to obtain the standard signal, the operational amplifier being configured to output an actually measured signal.

17. The method of claim 16, further comprising:
the FPGA setting the output of the operational amplifier from the high-impedance state to the enable state and setting the output of the standard signal output module from the enable state to the high-impedance state, to measure the actually measured signal.

18. The method of claim 1, further comprising:
the FPGA determining to enter a working mode; and
in the working mode:
the FPGA controlling a transmitter to emit a laser pulse sequence;
the FPGA receiving an electrical pulse signal, the electrical pulse signal being a signal converted from an optical signal returning along an emitting optical path of the laser pulse sequence after the emitted laser pulse sequence being reflected by an object; and
the FPGA performing the time measurement on the electrical pulse signal through the at least one TDC channel.

19. A field programmable gate array (FPGA) comprising:
at least one time-to-digital conversion (TDC) channel; and
a control device configured to:
determine that the FPGA enters a self-correction mode of time measurement; and
in the self-correction mode:
control to generate a standard signal, the standard signal being configured to correct the at least one TDC channel of the FPGA; and
control the FPGA to obtain the standard signal and collect measurement data of the at least one TDC channel based on the standard signal.

20. A distance measurement device comprising:
a transmitter configured to emit a laser pulse sequence; and
a field programmable gate array (FPGA) comprising:
at least one time-to-digital conversion (TDC) channel; and
a control device configured to:
determine that the FPGA enters a self-correction mode of time measurement;
in the self-correction mode:
control to generate a standard signal, the standard signal being configured to correct the at least one TDC channel of the FPGA; and
control the FPGA to obtain the standard signal and collect measurement data of the at least one TDC channel based on the standard signal;
wherein the FPGA is configured to control the transmitter to emit the laser pulse sequence, receive an electrical pulse signal, and perform the time measurement on the electrical pulse signal through the at least one TDC channel, the electrical pulse signal is converted from an optical signal returning along an emitting optical path of the laser pulse sequence after the laser pulse sequence is reflected by an object.
